(19) United States
(12) Patent Application Publication
(10) Pub. No.: US 2026/0350547 A1
(43) Pub. Date: Nov. 5, 2026

(54) HEURISTIC-BASED EMAIL AUTO LABELING

(71) Applicant: Notion Labs, Inc., San Francisco, CA (US)

(72) Inventor: Arpeet Kale, San Jose, CA (US)

(21) Appl. No.: 19/238,085

(22) Filed: Jun. 13, 2025

Related U.S. Application Data
(60) Provisional application No. 63/797,805, filed on Apr. 30, 2025.

(51) Int. Cl. G06Q 10/107; G06F 16/28

(52) U.S. Cl. CPC G06Q 10/107; G06F 16/285

(57) ABSTRACT

The system obtains a set of email messages. A portion of the set of email messages are associated with a label. The system inputs the set of email messages to a first artificial intelligence to generate, based on the set of emails messages, a first set of rules and a second set of rules. The first and second set of rules are stored in an accessible datastore. The system then obtains an additional email message and inputs it to a second artificial intelligence along with the first and second set of rules. Based on the additional email message, the first set of rules, and the second set of rules, the second artificial intelligence identifies an association between the additional email message and the label. In response to identifying the association between the additional email message and the label, the system applies the label to the additional email message.

### CROSS-REFERENCE TO RELATED APPLICATIONS

This application claims the benefit of U.S. Provisional Patent Application Ser. No. 63/797,805, filed Apr. 30, 2025, which is incorporated by reference herein in its entirety.

### BACKGROUND

Email communication has become an essential tool for both personal and professional interactions. The sheer volume of emails received daily can be overwhelming, leading to challenges in managing and organizing these communications effectively. To address this issue, emails in an inbox can be categorized by labels based on, for example, email topic. There remains a need for more sophisticated and accurate email classification methods to handle the ever-increasing complexity and volume of email data.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram of a transformer neural network, which may be used in examples of the present disclosure.

FIG. 3 is a block diagram illustrating a hierarchical organization of pages in a workspace.

FIG. 4A is a block diagram illustrating a system for generating heuristic rules for a new label.

FIG. 4B is a block diagram illustrating a system for applying a label to an email message.

FIG. 5 is an illustration of a string match module user interface.

FIG. 6 is an illustration of an email user interface with labeled email messages.

FIG. 7 is a flowchart illustrating a process for generating heuristic rules for a new label and applying the new label to an email message.

FIG. 8 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for generating heuristic rules for a new label and automatically applying the new label to an email message. To automatically apply the new label to an email message (e.g., an incoming email or a past unlabeled email), the present technology can use an artificial intelligence (AI) model to predict whether the new label applies to the email message. Predicting whether a label should apply to an email message is referred to herein as a “label inference.” Training a new AI model to make label inferences for each new label is not feasible given how frequently a user may wish to create a new label and given how few emails in the user's account may be relevant to the new label. Accordingly, some label inference techniques use few-shot learning with large language models (LLMs) to identify whether the new label should be applied to the email message. In these techniques, a handful of prior emails are selected from a user's email account. The prior emails are then categorized as emails that the new label applies to and emails that the new label does not apply to. Then, the categorized emails, along with the email in question (i.e., the email to be labeled) are sent to an LLM and the LLM determines whether the new label should be applied to the email in question.

For example, a user can create a new label “Promotion” for all emails sent to the user related to an ad or sale of a new product. With the few-shot method, six past emails can be selected from the user's email account. If three of those emails are ad or sale-related, those three emails can be labeled “Promotion” and the other three emails can be left without a label. The six categorized emails can then be fed into an LLM along with an email the user just received that the user wishes to label. The LLM can then determine, based on the six categorized emails, whether the email the user just received should receive the “Promotion” label.

The few-shot technique for label inferencing, however, has a variety of drawbacks. The handful of prior emails, as well as the email to be labeled, can include a large amount of text. When entered into an LLM, text is broken down into tokens, which are a basic unit of text used by an LLM to process entered data. Generally, a query sent to an LLM with a higher number of tokens increases the computing resources, time, power use, and cost required to respond to the query. Further, once an email is labeled successfully, the few-shot technique still requires the user to input the handful of prior emails along with each new email to label for every label inference. Thus, the few-shot technique can consume considerable resources, which only compound for each new email to label and for each new label created. Additionally, many users have intuitive rules (e.g., “mark all emails-from this sender as Important”), but the few-shot technique fails to not leverage or generalize these rule patterns explicitly, leading to more inefficiency.

Compared to the few-shot technique, the present technology reduces the number of tokens required for each label inference by generating heuristic rules for each new label. These heuristic rules can comprise short (e.g., sentence long) text strands that define when to apply, and when not to apply, the label to an email message. The present technology can then enter the rules and the new email for each label inference. The short rules used by the present technology can significantly reduce the number of tokens for each label inference when compared to the handful of emails required for each inference by the few-shot technique. Accordingly, the present technology can reduce the computing resources, time, power use, and cost required to conduct a label inference.

To generate the heuristic rules, the present technology can obtain a set of email messages. The set of email messages can include one or more email messages associated with a label (e.g., “Promotion”) and one or more email messages that are not associated with the label. The set of email messages can be input to a first artificial intelligence, which can generate a first set of rules based on the one or more email messages associated with the label and a second set of rules based on the one or more email messages that are not associated with the label. Then, to automatically apply the label to an email message (e.g., an incoming email message), the present technology can input the email message, the first set of rules, and the second set of rules to a second artificial intelligence. The second artificial intelligence can identify an association between the email message and the label based on the email message itself and the first and second set of rules. In response to identifying the association between the additional email message and the label, the present technology can automatically apply the label to the additional email message.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block's properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block's parent, which can be used for permissions. Blocks can be combined with other blocks to track progress and hold all project information in one place.

A block type is what specifies how the block is rendered in a user interface (UI), and the block's properties and content are interpreted differently depending on that type. Changing the type of a block does not change the block's properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block's ancestors all the way up to the root of the tree (which is the workspace). Trying to find this ancestor path by searching through all blocks' content arrays is inefficient, especially on the client. Instead, the model uses an “upward pointer”—the parent attribute—for the permission system. The upward parent pointers and the downward content pointers mirror each other.

A block's life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block's properties (an empty title, and checked: [[“No”]]). The client builds operations to represent the creation of a new block with those attributes. New blocks are not created in isolation: blocks are also added to their parent's content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model's servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the/saveTransactions API endpoint. Save Transactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member's client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

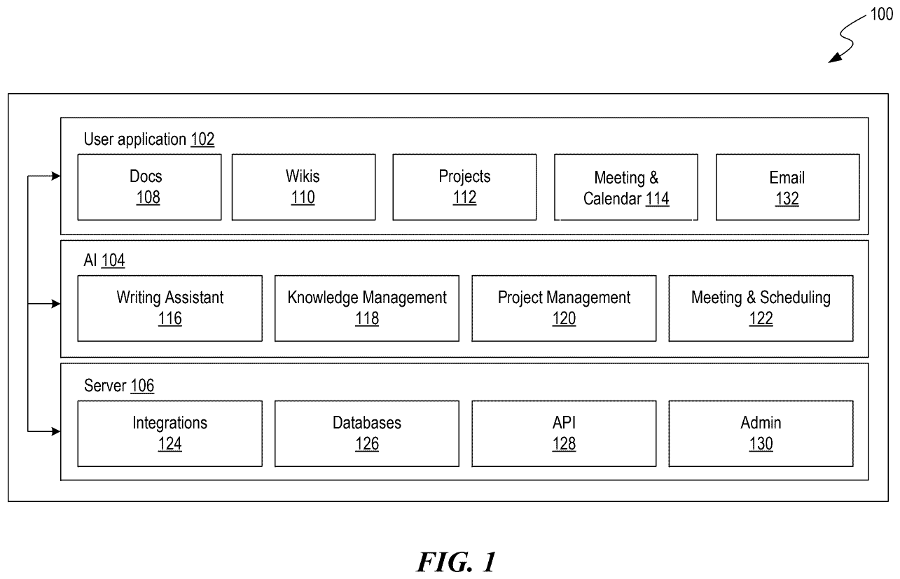

FIG. 1 is a block diagram of an example platform 100. The platform 100 provides users with an all-in-one workspace for data and project management. The platform 100 can include a user application 102, an artificial intelligence (AI) tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading), or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and an urgent information layout. Each view can include a customized structure including custom criteria, custom properties, and custom actions. The custom properties can be specific to a view such as AI-extracted properties and/or heuristic-based properties. The custom actions can trigger automatically when a message enters the view. The custom actions can include deterministic rules like “Archive this,” or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100 can include an embedding of a document within the platform 100, or an embedding of a block within the document. In another example, a wiki can link to a meeting within the calendar.

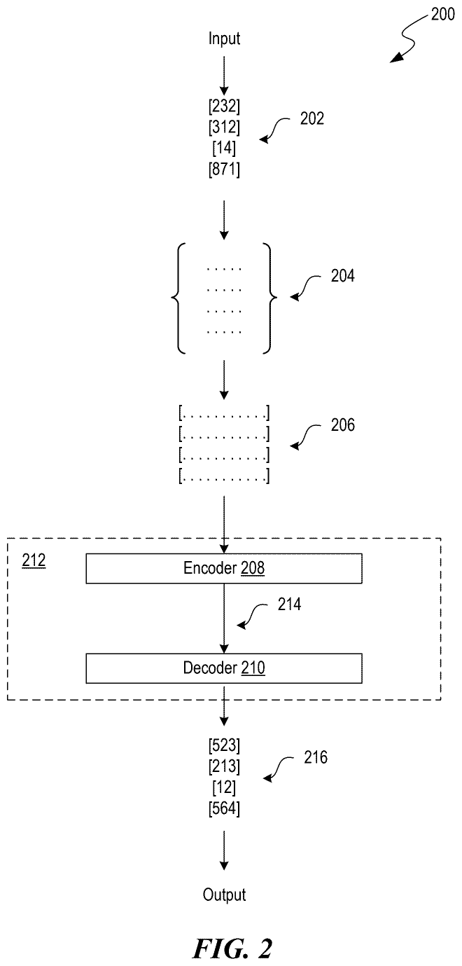

The AI tool 104 is an integrated AI assistant that enables AI-based functions for the user application 102. In one example, the AI tool 104 is based on a neural network architecture, such as the transformer 212 described in relation to FIG. 2. The AI tool 104 can interact with blocks embedded within the templates on a workspace of the user application 102. For example, the AI tool 104 can include a writing assistant tool 116, a knowledge management tool 118, a project management tool 120, and a meeting and scheduling tool 122. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include autofilling information based on changes within the workspace or automatically tracking project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. Unlike discriminative models, generative models are distinguished by their ability to create new, synthetic data that closely resembles the training data. In contrast, discriminative models focus on predicting labels for given inputs.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses large language models (LLMs).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 2 is a block diagram 200 of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as RNN-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

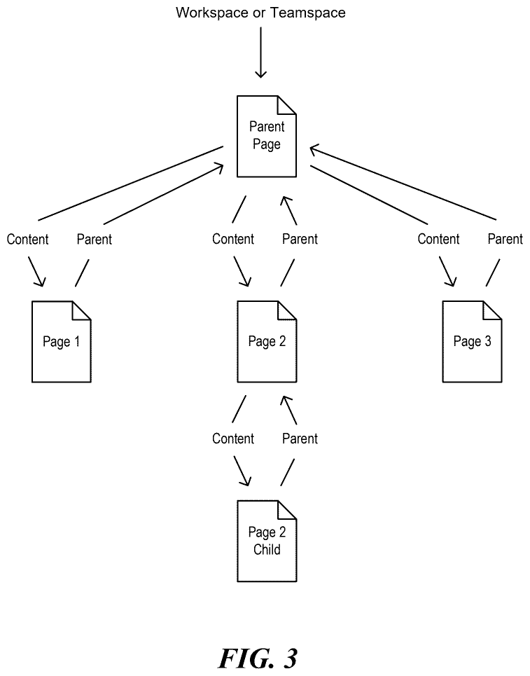

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child,” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent Page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page's access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### Heuristic-Based Email Auto Labeling

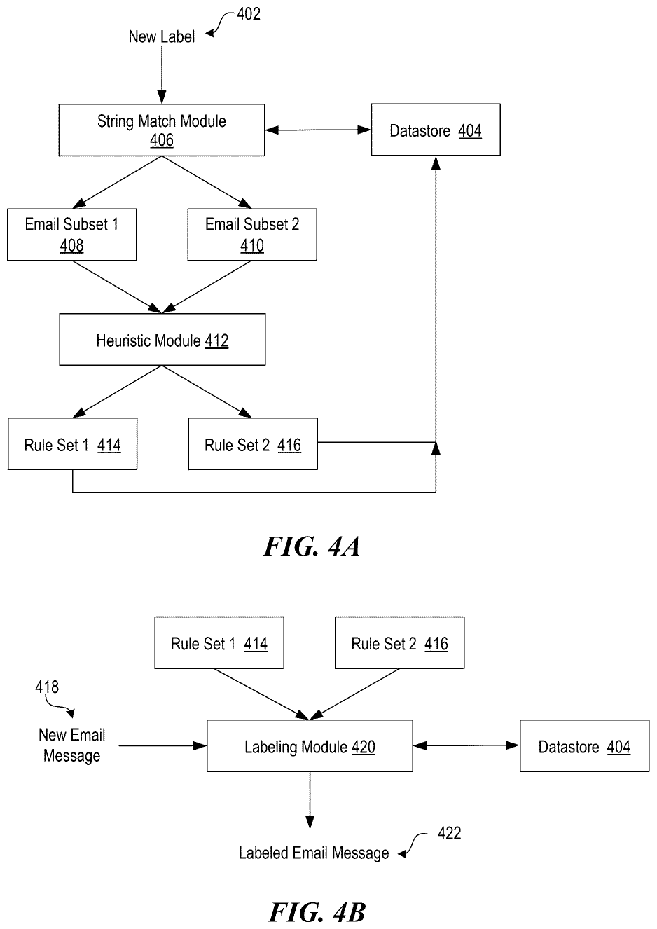

FIG. 4A is a block diagram illustrating a system for generating heuristic rules for a new label. The system includes a new label 402, a datastore 404, a string match module 406, email subset 1 408, email subset 2 410, heuristic module 412, rule set 1 414, and rule set 2 416. The heuristic module 412, as described further below, can be a first artificial intelligence (AI). Rule set 1 414 and rule set 2 416 can be the same rule set or different rule sets. If they are different rule sets, the rule set 1 414 can be a positive rule set identifying a first condition an email must satisfy to be included in the label, while rule set 2 416 can be a negative rule set identifying a second condition an email must satisfy to be excluded from the label. The new label 402 can be a text indicator created by a user to refer to a type of email in the user's email account. For example, the label can be the text “Promotion” and refer to ad and sale-related emails sent to the user. Other labels can include, for example, Spam, Advertisement, Social, Updates, Forums, Primary, Newsletters, Receipts, Finance, Work, etc. The labels can also be more specific to a user's activity (e.g., related to a specific type of work or hobby). For example, a recruiter's work email can include classifications associated with recruiting processes (e.g., Job Applications, Interview Schedules, Candidate Follow-ups, and Job Offers). In some embodiments, the new label 402 can be created by the system instead of created by the user.

The datastore 404 can be a variety of data storage devices including a server or an open-source cluster. An open-source cluster can refer to a collection of one or more servers (nodes) that work together to store, search, and analyze large volumes of data (e.g., email messages) in real time. Each server in the cluster holds a portion of the data and participates in the indexing and search capabilities to ensure high availability and scalability. The datastore 404 can include the emails associated with a user's account. The datastore 404 can also include heuristic rules created by the system for an email label (e.g., new label 402).

The string match module 406 creates email subset 1 408 and email subset 2 410. In some embodiments, the string match module 406 is configured to obtain email messages from the datastore 404 in response to a user creating new label 402. The number of emails obtained by string match module 406 span a single email, 5 emails, 10 emails, 100 emails, or more emails. In some embodiments, string match module 406 applies a key word search to the email messages in datastore 404 to determine which email messages to obtain. The key word search can be based on one or more words in the new label 402 and can be based on a meaning of the one or more words in the new label 402. For example, if the new label 402 is “Promotion,” the string match module 406 can search the datastore 404 for the word “Promotion” and can also search the datastore 404 for words within the meaning of “Promotion” like advertisement, sale, discount, etc. In some embodiments, string match module 406 can obtain portions of emails from the datastore 404. For example, string match module 406 can obtain only a subject line or only the body of an email in datastore 404.

Once the string match module 406 obtains the email messages from datastore 404, the string match module 406 creates email subset 1 408 and email subset 2 410 by categorizing the email messages. In some embodiments, to categorize the email messages, the string match module 406 prompts the user with each of the email messages and the user identifies whether each of the email messages is or is not associated with the new label 402. In other embodiments, the string match module 406 can include an AI model trained to automatically identify whether each of the email messages is or is not associated with the new label 402. With each of the email messages identified as associated or not associated with the new label 402, the string match module separates the email messages associated with the new label 402 into email subset 1 408 and the email messages not associated with the new label 402 into email subset 2 410.

The heuristic module 412 can be an AI model, as descried in this application. In some embodiments, heuristic module 412 can be an LLM or a small model (e.g., ChaptGPT-4o Mini). A small model is a model with fewer parameters than an LLM. For example, the LLM ChatGPT-4 can have trillions of parameters, whereas the small model ChatGPT-4o Mini has only 8 billion parameters. The heuristic module 412 can receive email subset 1 408 and email subset 2 410, process the emails in each subset, and generate rule set 1 414 and rule set 2 416 as an output. Rule set 1 414 can be heuristic rules, based on email subset 1 408 that describe when an email message is associated with the new label 402 and should therefore have the new label 402 applied to the email message. Rule set 2 416, on the other hand, can be heuristic rules, based on email subset 2 410 that describe when an email message is not associated with the new label 402 and should therefore not have the new label 402 applied to the email message. The heuristic rules of rule set 1 414 and rule set 2 416 can be stored in datastore 404 once generated by the heuristic module 412.

In the case that new label 402 is the text “Promotion,” the heuristic rules of rule set 1 414, generated by the heuristic module 412 can include: “Email message contains offers or discounts (e.g., ‘15% off’),” “Email message promotes a limited-time sale or urgency,” and “Email contains a call to action that encourages immediate purchasing.” On the other hand, the heuristic rules of rules set 2 416, generated by the heuristic module 412 can include: “Email focuses on community news or events without focusing on promotional content,” “Email does not contain any offers, discounts, or sales information,” and “Email is primarily informational or educational.” The heuristic rules of rule set 1 414 and rule set 2 416 can be human-readable rules (e.g., text like above), machine-readable rules (e.g., code), or both (e.g., natural language readable by humans and NLPs).

The heuristic rules of rule set 1 414 and rule set 2 416 can be the basis for label inferencing (i.e., determining whether the new label 402 should be applied to an email message) as described with respect to FIG. 4B below. Additionally, the heuristic rules of rule set 1 414 and rule set 2 416 can be used for other tasks including answering a question input the user to a chatbot integrated into the software of the user's email account, writing a summary of a particular email, or predicting heuristic rules for another label the user wishes to create.

FIG. 4B is a block diagram illustrating a system for applying a label to an email message. The system includes the rule set 1 414 and the rule set 2 416, generated based on the new label 402, from FIG. 4A. Additionally, the system includes a new email message 418, a labeling module 420, datastore 404, and labeled email message 422. The labeling module 420 can be a second AI, as described in this application. The new email message 418 can be an email message recently received to an email account of the user. In some embodiments, the new email message 418 can be an email message (e.g., a previously unlabeled email message) already associated with the user's email account stored within datastore 404.

The new email message 418, the rule set 1 414, and the rule set 2 416 can be input to labeling module 420 to determine whether the new label 402 applies to the new email message 418. Labeling module 420 can be an AI model. In some embodiments, the labeling module 420 can be an LLM or a small model (e.g., ChaptGPT-4o Mini). A small model is a model with fewer parameters than an LLM. For example, the LLM ChatGPT-4 can have trillions of parameters, whereas the small model ChatGPT-4o Mini has only 8 billion parameters. To analyze the application of the new label 402 to the new email message 418, the labeling module 420 processes the text of the new email message 418 in light of the rule set 1 414 and the rule set 2 416. The rule set 1 414 and the rule set 2 416 can be input to the labeling module 420 from the datastore 404 or, in other embodiments, can be input to the labeling module 420 directly from the heuristic module 412.

If the labeling module 420 determines that the new label 402 should be applied to the new email message 418, then the labeling module 420 attaches the new label 402 to the new email message 418 creating labeled email message 422. The labeled email message 422 can be sent to datastore 404 for storage. If the labeling module 420 determines that the new label 402 should not be applied to the new email message 418, then the labeling module 420 foregoes attaching the new label 402 to the new email message 418. With the new label 402 not attached to the new email message 418, the system can cause the labeling module 420 to check whether another label (based on rule sets from previously created labels) should be applied to the new email message 418. Alternatively, with the new label 402 not attached to the new email message 418, the system can simply leave the new email message 418 unlabeled.

As an example of the FIG. 4B process, take the case that new email message 418 is a promotional email message including language like “apply now for our holiday sale sweepstakes!” Input to the labeling module 420, the labeling module 420 can compare this email text to the rules for the new label 402 “Promotion” (as described in an example above in FIG. 4A) to determine whether the “Promotion” label should be applied to the new email message 418. Since the text of the new email message 418 falls under the rules of the rules set 1 414 (requesting that an individual “apply now” for a “sweepstakes” promotes a limited-time sale and urgency), the labeling module 420 would determine that the “Promotion” label should apply to the new email message 418. Accordingly, the labeling module 420 can attach the “Promotion” label to the new email message 418 creating labeled email message 422 that is then stored in datastore 404.

As compared to the few-shot technique for determining whether to apply a label to an email message, the heuristic-based labeling of FIGS. 4A and 4B, reduces the number of tokens required for each label inference. The number of tokens for each label inference are reduced by generating the relatively short heuristic rule text strands (e.g., the rule set 1 414 and the rules set 2 416) for each new label that are applied by the labeling module 420 for each new label inference, instead of requiring multiple previous emails along with the new email message 418. Accordingly, the present technology reduces the computing resources, time, power use, and cost required to conduct a label inference by at least 5 times and as large as 1000 times. Effectively, by using a small language model that has 1000 parameters less than a large language model, the system reduces the computing cycles, memory, time and power use by a thousand times.

In some embodiments, the present technology includes a feedback loop. The feedback loop allows a user to identify whether labeled email message 422 was labeled correctly with the new label 402. If labeled email message 422 was not labeled correctly, the user can remove or change its label. Once the labeled email message 422 is updated by the user, the feedback loop can input the updated labeled email message 422 to the email subset 2 410 of FIG. 4A. inputting the updated labeled email message 422 to the email subset 2 410 gives the heuristic module 412 an additional data point to refine the rule set 1 414 and the rule set 2 416. Refining these rule sets as described can improve the accuracy of labeling module 420 when an additional email message needs a label.

In other embodiments, the labeling module 420 can return a confidence level for whether the new label 402 should be applied to the new email message 418 and, based on the confidence level, suggest to the user whether the new label 402 should be applied to the new email message 418. For example, based on the text of the new email message 418 and the heuristic rules of rule set 1 414 and rule set 2 416, the labeling module 420 may return a 70% confidence level that the new label 402 applies and thereby suggest to the user that the new label 402 be applied to the new email message 418. With this suggestion, the user can select that the new label 402 apply (creating newly labeled email message 422) or reject its application. In some embodiments, once the user selects that the new label 402 does apply, a feedback loop of the present technology can add the newly labeled email message 422 to email subset 1 408. Alternatively, once the user selects that the new label 402 does not apply, the feedback loop of the present technology can add the new email message 418 (without the new label 402) to the email subset 2 410.

In yet further embodiments, the heuristic rules of rule set 1 414 and rule set 2 416 can be converted into rules of an email platform (e.g., Outlook or Gmail rules) to automatically sort and label emails within the email account and received by the email account. In such embodiments, the email platform itself, along with the converted rules, act as labeling module 420.

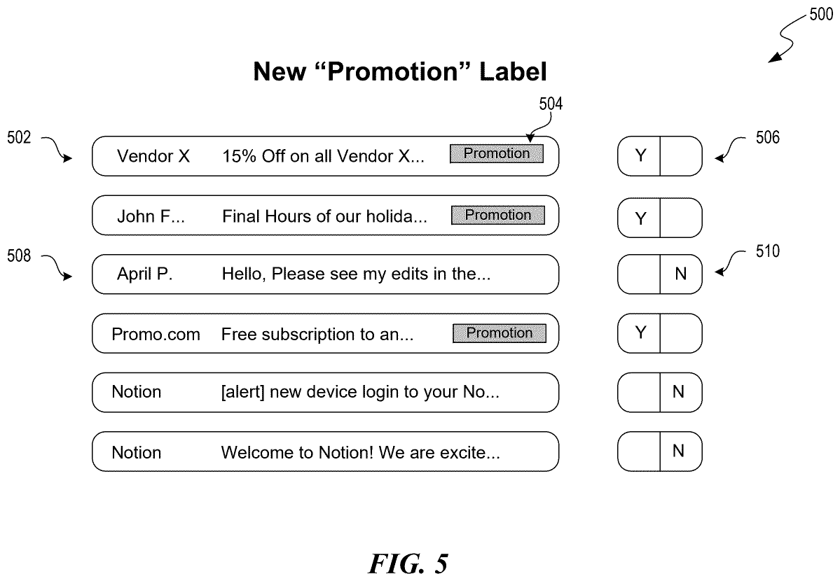

FIG. 5 is an illustration of a string match module (e.g., string match module 406 of FIG. 4A) user interface 500. The string match module user interface 500 includes a first email message 502, with a corresponding label 504 and first classification input 506, and a second email message 508, without a corresponding label but having a second classification input 510. As shown, the string match module user interface 500 can obtain email messages (as described in FIG. 4A) and present the email messages to a user for classification. To classify the email messages, the user can select, through the string match module user interface 500, whether each email corresponds to the relevant label or not. For example, in the case the label (e.g., the new label 402 of FIG. 4A) is “Promotion,” the user can identify whether the obtained emails should be classified as promotional emails or not. Accordingly, for the first email message 502 from Vendor X, the user can confirm that the label 504 of “Promotion” applies by selecting “Y” in the first classification input 506. For the second email message 508 from April P., the user can confirm that the “Promotion” label should not apply by selecting “N” in the second classification input 510. Selections of the classification inputs 506 and 510 can be represented by “Y” and “N,” as well as other positive and negative indications including a check mark and cross mark, the words “Yes” and “No,” a green color and a red color, etc.

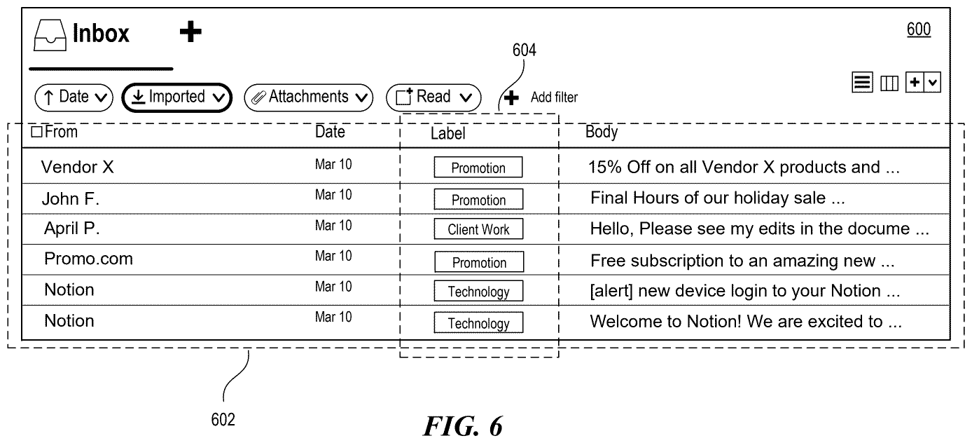

FIG. 6 is an illustration of an email user interface 600 (e.g., a graphical user interface (GUI)) with labeled email messages. As shown, the email user interface 600 includes multiple email messages 602 arranged in a table including rows and columns. Each row in the table corresponds to one email message, and the columns indicate properties associated with the respective email messages (a sender, a date received, a label, an email). The table also includes a column 604 indicating a label for each of the messages (e.g., “Promotion,” “Client Work,” and “Technology”). The labels can correspond to the labels described with respect to FIGS. 4A-5. The labels can enable organization and searchability of emails. For example, a user could search for emails associated with a particular label or organize the email messages in the table according to the labels (e.g., grouping the emails), or the labels could provide a quick indication of what the email is associated with and/or its importance.

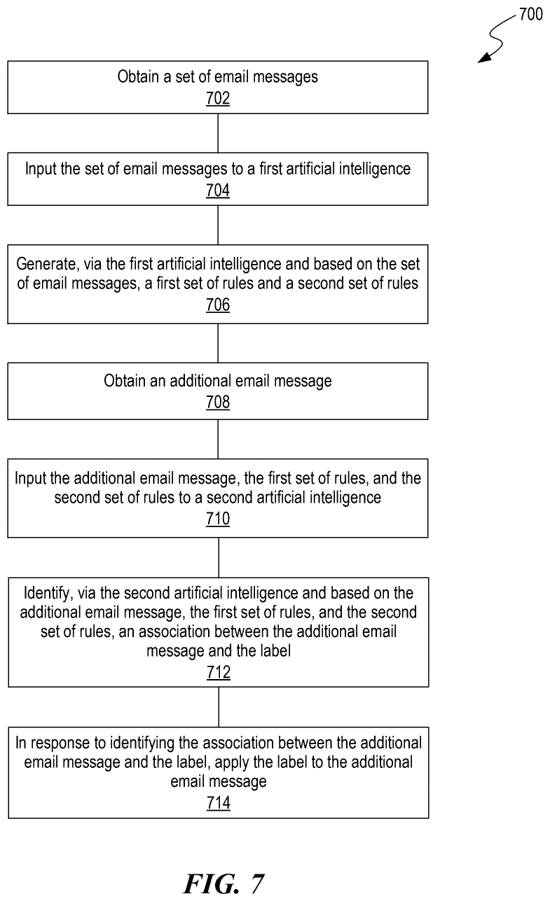

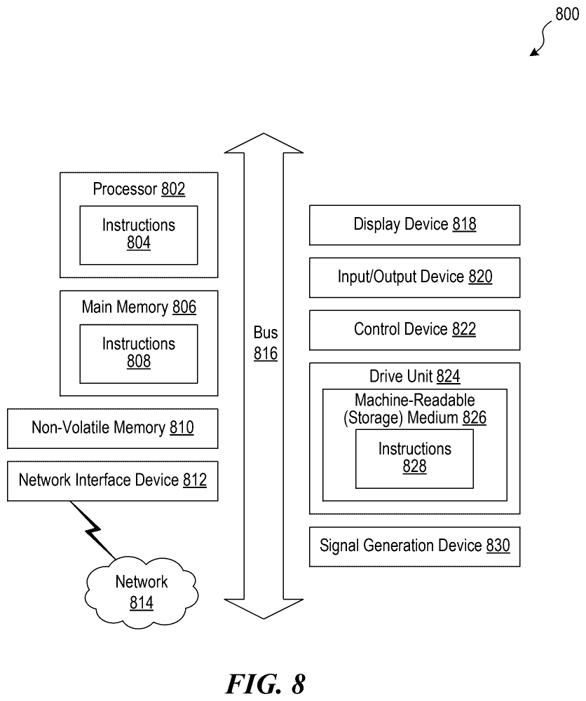

FIG. 7 is a flowchart illustrating a process 700 for generating heuristic rules for a new label and applying the new label to an email message. The processes can be performed by a heuristic-based email auto labeling system such as the heuristic-based email auto labeling system described with respect to FIGS. 4A and 4B. The system can be a computer system (e.g., the computer system 800 described with respect to FIG. 8).

At 702, the system obtains a set of email messages. Each email message of the set of email messages can include a text property including an email subject (e.g., a headline or title for the email message) and an email body (e.g., the main content section of an email message including text, images, and/or other multimedia elements that convey the message's information and purpose). In some embodiments, the text property can additionally or optionally include a name of a sender, a name of a receiver, metadata, attachments, or other text information associated with the email message. The process 700 is described with respect to processing of the email body and the email subject but can be similarly applied to any other text content.

The set of email messages can be associated with a user account. For example, the receiver email address of each email message can be associated with the user account, or the sender email address of each email message can be associated with the user account (i.e., the email message was generated and sent by the user account). The set of emails can be stored in a datastore (e.g., datastore 404 of FIG. 4A) of the user account.

Further, the set of email messages can include a first subset of email messages corresponding to one or more email messages associated with a label as well as a second subset of email messages corresponding to one or more email messages unassociated with the label. For example, the first subset of email messages can all include a label “Promotion” and the second subset of email messages can all lack the label “Promotion.”

In some embodiments, the set of email messages can be obtained by searching a second set of email messages (e.g., all email messages associated with the user account in a datastore) for one or more key words. These one or more key words can be words based on the label. For example, for a label “Promotion,” the key words can be “Promotion,” “Sale,” “Advertisement,” “Discount,” etc. Then, after searching the second set of email messages, the system can select two or more email messages from the second set of email messages that include the one or more key words.

In other embodiments, the first and second subsets of email messages can be determined, in part, by user input. In these embodiments, the system can receive, from a user, a label (e.g., a new “Promotion” label that the user wishes to create). With the new label input, the system can obtain the set of email messages based on a key word search as described above and generate a graphical user interface that includes a graphical representation of the set of email messages. Then, in response to a positive or negative indication (e.g., a positive indication of a check mark for an email that includes a promotion or a negative indication of a cross mark for an email that does not include a promotion) applied, through the graphical user interface, by the user to each email message of the set of email messages, the system can generate the first subset of email messages and the second subset of email messages. For example, in response to a positive indication to a first email message, the system can include the first email message in the first subset of email messages. Alternatively, in response to a negative indication to a second email message, the system can include the second email message in the second subset of email messages.

At 704, the system inputs the set of email messages to a first artificial intelligence (AI). The first AI model can be an AI model. In some embodiments, the first AI model can be an LLM or a small model (e.g., ChaptGPT-40 Mini). A small model is a model with fewer parameters than an LLM. For example, the LLM ChatGPT-4 can have trillions of parameters, whereas the small model ChatGPT-4o Mini has only 8 billion parameters. The first AI can also be a model as described with respect to FIG. 2 above.

At 706, the system generates a first set of rules and a second set of rules via the first AI based on the set of email messages. The first set of rules and the second set of rules can be heuristic rules comprising relatively short strands of text (e.g., one to two sentences). In some embodiments, each set of rules are human-readable (e.g., English text). In other embodiments, each set of rules are machine-readable (e.g., computer code, or in the case of LLM processing, written language text). The first set of rules can correspond to the first subset of email messages and the second set of rules can correspond to the second subset of email messages. Examples of the heuristic rules in the context of a label “Promotion” are given above with respect to FIG. 4A. In some embodiments, once the system generates the first set of rules and the second set of rules, the system can store each set of rules in a datastore accessible by the system (e.g., datastore 404 in FIG. 4A).

At 708, the system obtains an additional email message. The additional email message can be an email message recently received to the user email account. In some embodiments, the additional email message can be an email message (e.g., a previously unlabeled email message) already associated with the user's email account stored within a datastore accessible by the system (e.g., datastore 404 in FIG. 4A).

At 710, the system inputs the additional email message, the first set of rules, and the second set of rules to a second AI. The second AI model can be an AI model. In some embodiments, the first AI model can be an LLM or a small model (e.g., ChaptGPT-4o Mini). In some embodiments, the first AI and the second AI are the same AI. In other embodiments, the first AI and the second AI are different. In such embodiments, the first AI can be a small model trained to efficiently identify heuristic rules for a set of email messages and the second AI can be another small model trained to efficiently determine whether an email should be labeled based on heuristic rules. In another embodiment, the first AI can be a large model having trillions of weights, while the second AI can be a small model having approximately billion weights.

At 712, the system identifies, via the second AI and based on the additional email message, the first set of rules, and the second set of rules, an association between the additional email message and the label. For example, an association between the additional email message and a label “Promotion” can be identified when the additional email message includes the language “apply now for our holiday sale sweepstakes!” and a heuristic rule for the label “Promotion” is “Email message promotes a limited-time sale or urgency.” In some embodiments, and as described above, identifying an association between the additional email message and the label based on the additional email message, the first set of rules, and the second set of rules, can require fewer computational resources than identifying the association between the additional email message and the label based on the set of email messages and the additional email message.

At 714, the system, in response to identifying the association between the additional email message and the label, applies the label to the additional email message. In some embodiments, the system can generate, via the second AI, a confidence level corresponding to the identified association between the additional email message and the label. For example, based on the information received by the second AI, the second AI may be 70% confident that the label “Promotion” applies to the additional email message. In other embodiments, in response to the confidence level determined by the second AI being lower than a particular threshold (e.g., lower than a 60% threshold), the system can forego automatically applying the label to the additional email message and instead query a user whether to apply the label to the additional email message.

### Computer System

FIG. 8 is a block diagram that illustrates an example of a computer system 800 in which at least some operations described herein can be implemented. As shown, the computer system 800 can include: one or more processors 802, main memory 806, non-volatile memory 810, a network interface device 812, a display device 818, an input/output device 820, a control device 822 (e.g., keyboard and pointing device), a drive unit 824 that includes a machine-readable (storage) medium 826, and a signal generation device 830 that are communicatively connected to a bus 816. The bus 816 represents one or more physical buses and/or point-to-point connections that are connected by appropriate bridges, adapters, or controllers. Various common components (e.g., cache memory) are omitted from FIG. 8 for brevity. Instead, the computer system 800 is intended to illustrate a hardware device on which components illustrated or described relative to the examples of the figures and any other components described in this specification can be implemented.

The computer system 800 can take any suitable physical form. For example, the computer system 800 can share a similar architecture as that of a server computer, personal computer (PC), tablet computer, mobile telephone, wearable electronic device, network-connected (“smart”) device (e.g., a television or home assistant device), augmented reality/virtual reality (AR/VR) system (e.g., head-mounted display), or any electronic device capable of executing a set of instructions that specify action(s) to be taken by the computer system 800. In some implementations, the computer system 800 can be an embedded computer system, a system-on-chip (SOC), a single-board computer (SBC) system, or a distributed system such as a mesh of computer systems or include one or more cloud components in one or more networks. Where appropriate, one or more computer systems 800 can perform operations in real time, near real time, or in batch mode.

The network interface device 812 enables the computer system 800 to mediate data in a network 814 with an entity that is external to the computer system 800 through any communication protocol supported by the computer system 800 and the external entity. Examples of the network interface device 812 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 806, non-volatile memory 810, machine-readable medium 826) can be local, remote, or distributed. Although shown as a single medium, the machine-readable medium 826 can include multiple media (e.g., a centralized/distributed database and/or associated caches and servers) that store one or more sets of instructions 828. The machine-readable medium 826 can include any medium that is capable of storing, encoding, or carrying a set of instructions for execution by the computer system 800. The machine-readable medium 826 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 810, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 804, 808, 828) set at various times in various memory and storage devices in computing device(s). When read and executed by the processor 802, the instruction(s) cause the computer system 800 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A non-transitory, computer-readable storage medium comprising instructions recorded thereon, wherein the instructions, when executed by at least one data processor of a system, cause the system to:
obtain a set of email messages,
wherein the set of email messages includes a first subset of email messages corresponding to one or more email messages associated with a label;
wherein the set of email messages includes a second subset of email messages corresponding to one or more email messages unassociated with the label;
input the set of email messages to a first artificial intelligence that is configured to generate one or more sets of heuristic rules that are associated with the label;
generate, via the first artificial intelligence and based on the set of email messages, a first set of rules and a second set of rules,
wherein the first set of rules corresponds to the first subset of email messages; and
wherein the second set of rules corresponds to the second subset of email messages;
obtain an additional email message;
input the additional email message, the first set of rules, and the second set of rules to a second artificial intelligence that is configured to use the one or more sets of heuristic rules to determine whether to apply the label to the additional email message.
wherein the second artificial intelligence differs from the first artificial intelligence;
identify, via the second artificial intelligence and based on the additional email message, the first set of rules, and the second set of rules, an association between the additional email message and the label; and
in response to identifying the association between the additional email message and the label, apply the label to the additional email message.

2. The non-transitory, computer-readable storage medium of claim 1, wherein identifying, via the second artificial intelligence and based on the additional email message, the first set of rules, and the second set of rules, the association between the additional email message and the label requires fewer computational resources than identifying, via the second artificial intelligence, the association between the additional email message and the label based on the set of email messages and the additional email message.

3. The non-transitory, computer-readable storage medium of claim 1, wherein to obtain the set of email messages the system is further caused to:
search a second set of email messages for one or more key words,
wherein the one or more key words are based on the label;
wherein the second set of email messages is associated with a user account; and
select two or more email messages from the second set of email messages,
wherein the two or more email messages include the one or more key words.

4. The non-transitory, computer-readable storage medium of claim 1, wherein the system is further caused to:
receive, from a user, the label;
generate a graphical user interface that includes a graphical representation of the set of email messages;
in response to a positive indication applied, via the graphical user interface, by the user to a first email message of the set of email messages, include the first email message in the first subset of email messages; and
in response to a negative indication applied, via the graphical user interface, by the user to a second email message of the set of email messages, include the second email message in the second subset of email messages.

5. The non-transitory, computer-readable storage medium of claim 1, wherein the system is further caused to:
store, in a datastore accessible by the system, the first set of rules and the second set of rules,
wherein the first set of rules and the second set of rules are human-readable; and
wherein the first set of rules and the second set of rules are machine-readable.

6. The non-transitory, computer-readable storage medium of claim 1, wherein the first artificial intelligence and the second artificial intelligence each comprise:
a large language model; or
a small model,
wherein the small model includes fewer parameters than the large language model.

7. The non-transitory, computer-readable storage medium of claim 1, wherein the system is further caused to:
generate, via the second artificial intelligence, a confidence level corresponding to the identified association between the additional email message and the label; and
in response to the confidence level being lower than a particular threshold, via the second artificial intelligence, forego applying the label to the additional email message and query a user whether to apply the label to the additional email message.

8. A system comprising:
at least one hardware processor; and
at least one non-transitory memory storing instructions, which, when executed by the at least one hardware processor, cause the system to:
obtain a set of email messages,
wherein the set of email messages includes a first subset of email messages corresponding to one or more email messages associated with a label;
wherein the set of email messages includes a second subset of email messages corresponding to one or more email messages unassociated with the label;
input the set of email messages to a first artificial intelligence that is configured to generate one or more sets of heuristic rules that are associated with the label;
generate, via the first artificial intelligence and based on the set of email messages, a set of rules,
wherein the set of rules indicate a first condition that a first email message needs to satisfy to be included in the label, and
wherein the set of rules indicates a second condition that a second email message needs to satisfy to be excluded from the label;
obtain an additional email message;
input the additional email message and the set of rules to a second artificial intelligence that is configured to use the one or more sets of heuristic rules to determine whether to apply the label to the additional email message, wherein the second artificial intelligence differs from the first artificial intelligence;
identify, via the second artificial intelligence and based on the additional email message and the set of rules an association between the additional email message and the label; and
in response to identifying the association between the additional email message and the label, apply the label to the additional email message.

9. The system of claim 8, wherein identifying, via the second artificial intelligence and based on the additional email message and the set of rules, the association between the additional email message and the label requires fewer computational resources than identifying, via the second artificial intelligence, the association between the additional email message and the label based on the set of email messages and the additional email message.

10. The system of claim 8, wherein to obtain the set of email messages the system is further caused to:
search a second set of email messages for one or more key words,
wherein the one or more key words are based on the label;
wherein the second set of email messages is associated with a user account; and
select two or more email messages from the second set of email messages,
wherein the two or more email messages include the one or more key words.

11. The system of claim 8, wherein the system is further caused to:
receive, from a user, the label;
generate a graphical user interface that includes a graphical representation of the set of email messages;
in response to a positive indication applied, via the graphical user interface, by the user to a first email message of the set of email messages, include the first email message in the first subset of email messages; and
in response to a negative indication applied, via the graphical user interface, by the user to a second email message of the set of email messages, include the second email message in the second subset of email messages.

12. The system of claim 8, wherein the system is further caused to:
store, in a datastore accessible by the system, the set of rules,
wherein the set of rules are human-readable; and
wherein the set of rules are machine-readable.

13. The system of claim 8, wherein the system is further caused to:
generate, via the second artificial intelligence, a confidence level corresponding to the identified association between the additional email message and the label; and
in response to the confidence level being lower than a particular threshold, via the second artificial intelligence, forego applying the label to the additional email message and query a user whether to apply the label to the additional email message.

14. A method comprising:
obtaining a set of email messages,
wherein the set of email messages includes a first subset of email messages corresponding to one or more email messages associated with a label;
wherein the set of email messages includes a second subset of email messages corresponding to one or more email messages unassociated with the label;
inputting the set of email messages to a first artificial intelligence that is configured to generate one or more sets of heuristic rules that are associated with the label;
generating, via the first artificial intelligence and based on the set of email messages, a set of rules,
wherein the set of rules indicate a first condition that a first email message needs to satisfy to be included in the label; and
wherein the set of rules indicates a second condition that a second email message needs to satisfy to be excluded from the label; obtaining an additional email message;
inputting the additional email message and the set of rules to a second artificial intelligence that is configured to generate one or more sets of heuristic rules that are associated with the label,
wherein the second artificial intelligence differs from the first artificial intelligence;
identifying, via the second artificial intelligence and based on the additional email message and the set of rules, an association between the additional email message and the label;
in response to identifying the association between the additional email message and the label, applying the label to the additional email message.

15. The method of claim 14, wherein identifying, via the second artificial intelligence and based on the additional email message and the set of rules, the association between the additional email message and the label requires fewer computational resources than identifying, via the second artificial intelligence, the association between the additional email message and the label based on the set of email messages and the additional email message.

16. The method of claim 14, wherein obtaining the set of email messages further comprises:
searching a second set of email messages for one or more key words,
wherein the one or more key words are based on the label;
wherein the second set of email messages is associated with a user account; and
selecting two or more email messages from the second set of email messages,
wherein the two or more email messages include the one or more key words.

17. The method of claim 14, further comprising:
receiving, from a user, the label;
generating a graphical user interface that includes a graphical representation of the set of email messages;
in response to a positive indication applied, via the graphical user interface, by the user to a first email message of the set of email messages, including the first email message in the first subset of email messages; and
in response to a negative indication applied, via the graphical user interface, by the user to a second email message of the set of email messages, including the second email message in the second subset of email messages.

18. The method of claim 14, further comprising:
storing the set of rules,
wherein the set of rules are human-readable; and
wherein the set of rules are machine-readable.

19. The method of claim 14, wherein the first artificial intelligence and the second artificial intelligence each comprise:
a large language model; or
a small model,
wherein the small model includes fewer parameters than the large language model.

20. The method of claim 14, further comprising:
generating, via the second artificial intelligence, a confidence level corresponding to the identified association between the additional email message and the label; and
in response to the confidence level being lower than a particular threshold, via the second artificial intelligence, forego applying the label to the additional email message and querying a user whether to apply the label to the additional email message.
